(19) United States
(12) Patent Application Publication
(10) Pub. No.: US 2009/0006986 A1
(43) Pub. Date: Jan. 1, 2009

(54) Method and system for accessing online applications using a web browser

(76) Inventor: Luc Martin, Cantley (CA)

Correspondence Address: Brian P. Hopkins, Esq.;Mintz, Levin, Cohn, Ferris, Glovsky and Popeo, P.C, The Chrysler Center, 666 Third Avenue, 24th Floor, New York, NY, 10017, US

(21) Appl. No.: 12/152,331

(22) Filed: May 13, 2008

Related U.S. Application Data
(63) Continuation of application No. 10/523,255, filed on Jan. 26, 2005.
(60) Provisional application No. 60/398,580, filed on Jul. 26, 2002.

(51) Int. Cl. G06F 3/00; G09G 5/00; G06F 17/21

(52) U.S. Cl. 715/760

(57) ABSTRACT

A method and system for accessing online software applications using a Web browser. The system displays buttons linked to online software applications. Clicking on a button displays the start page of the online software application associated with that link in a display area in the content window of a Web browser. The user interface of the system can resemble a virtual Personal Digital Assistant.

### FIELD OF THE INVENTION

The present invention relates to a method and system for interacting with an online software application using a Web browser.

### BACKGROUND OF THE INVENTION

A Personal Digital Assistant or PDA is a device that provides computing and information storage and retrieval capabilities for personal or business use. Software applications may be loaded into a PDA to perform specific tasks. PDAs are often used for keeping schedule, calendar, and address book information organized. Examples of PDA software applications include: Address Book, Calculator and To Do List. A PDA may have several input/output devices such as a keyboard or an electronically sensitive pad, on which handwriting can be received, speakers, display area, microphone and communication peripherals.

PDA software applications can be loaded on a PDA. A PDA software application can reside permanently on a PDA, or it can be loaded and unloaded dynamically by the user. Buttons on a PDA are often used to allow direct access to a PDA software application and for easily switching from one software application to another.

Increasing, with the trend to “Web top” applications from “desk top” applications, online software applications are accessed via a Web site. A Web browser, such as Microsoft™ Internet Explorer and Netscape™ Navigator, can be used to access an online software application by accessing the server on which the software application resides. The Web site usually provides a link, which can be “clicked” to provide access to the software application. However, PDA-type functionality for accessing an online software application or switching from one online software application to another is not provided at a conventional Web site. Furthermore, a user cannot modify the access functionality to suit his/her needs.

There is a need therefore, to provide PDA-type functionality for accessing online software applications when using a Web browser.

### SUMMARY OF THE INVENTION

It is an object of one aspect of the invention to provide a system for accessing online software applications when using a Web browser.

It is an object of another aspect of the invention to provide a method for interaction between a Web browser on one computer and an online software application on another computer.

It is an object of a further aspect of the invention to provide a method of accessing an online software application under the control of a server system using a Web browser.

It is an object of still another aspect of the invention to provide a system for creating buttons on a Web page, associating the buttons with an online software application and displaying online software applications on the Web page in response to selection of the buttons.

It is an object of a still further aspect of the invention to provide a method of associating an online software application with a graphical user interface displayable in a content window of a Web browser.

According to one aspect of the invention, there is provided a graphical user interface displayable in a content window of a Web browser for accessing an online software application, comprising: a button, the button programmed with a URL of a start page of the online software application; whereby, clicking on the button causes the start page of the online software application to be displayed in a display area.

According to another aspect of the invention, there is provided a method for interaction between a Web browser on a first computer and an online software application on a second computer, the method comprising the steps of: initiating an application on the first computer to open a graphical user interface in the content window of the Web browser, the interface including a button, the button programmed with a URL of a start page of the online software application; and accessing the start page using the button, thereby causing the start page to be displayed in a display area to permit interaction with the online software application.

According to a further aspect of the invention, there is provided a method of accessing an online software application under control of a server system, comprising the steps of: displaying in a Web browser, a button programmed with the URL of a start page of the online software application; sending a request to the server system to access the start page of the software application in response to selection of the button; and displaying the requested start page in a display area.

According to yet another aspect of the invention, there is provided a system comprising: means for creating one or more button means associated with one or more start pages of one or more online software applications; means for making available the button means via a Web page; means for selecting one of the button means; and means for displaying the start page of the online software application associated with the selected button means in a display area in response to selection of the button means.

According to a still further aspect of the invention, there is provided a method of associating an online software application with a graphical user interface displayable in a content window of a Web browser, the graphical user interface comprising a button associable with a URL for a start page of the online software application, whereby selecting the button causes the online software application to be displayed in a display area, the method comprising the steps of: locating an instance of a first online software application using the Web browser; and causing the button to be associated with the URL of the start page of the instance of the first online software application.

Advantageously, the present invention provides a system and method for accessing software applications when using a Web browser. Another advantage of the present invention is that it provides a method for interaction between a Web browser on one computer and an online software application on another computer. A further advantage of the present invention is that it provides a system for creating buttons on a Web page and associating those buttons with online software applications so that the online software applications are displayed on the Web page in response to selection of the buttons. Another advantage of the present invention is that it provides a method of associating an online software application with a graphical user interface displayable in a content window of a Web browser.

Further objects and advantages of the present invention will be apparent from the following description, wherein various embodiments of the invention are clearly described and shown.

### BRIEF DESCRIPTION OF THE DRAWINGS

The present invention will be further understood from the following description of preferred embodiments with reference to the drawings in which:

FIG. 1 is a representation of a printout of a Web page with a target frame and menu links displayed in a Web browser window;

FIG. 2 is a representation of a VPDA according to the invention displayed in a Web browser window;

FIG. 3 shows representations of various states of an embodiment of a VPDA interface according to the invention;

FIG. 4 is a diagram providing an overview of a system context in which an embodiment of the invention may be used;

FIG. 5 is a diagram depicting the loading of online software applications into a VPDA;

FIG. 6 is a flow diagram illustrating a method by which an administrator loads an existing software application instance onto a VPDA;

FIG. 7 is a flow diagram illustrating a method by which an administrator loads a newly created software application instance onto a VPDA;

FIG. 8 is a flow diagram illustrating a method whereby a user loads an existing software application instance onto a VPDA;

FIG. 9 is a representation of an online form for loading an existing software application instance onto a VPDA;

FIG. 10 is a flow diagram illustrating a method whereby a user loads a newly created software application instance onto a VPDA;

FIG. 11 is a representation of an online form for loading a newly created software application instance onto a VPDA; and

FIG. 12 is an alternate embodiment of a VPDA.

Similar reference numerals are used in different figures to denote similar components.

### DETAILED DESCRIPTION OF THE PREFERRED EMBODIMENT

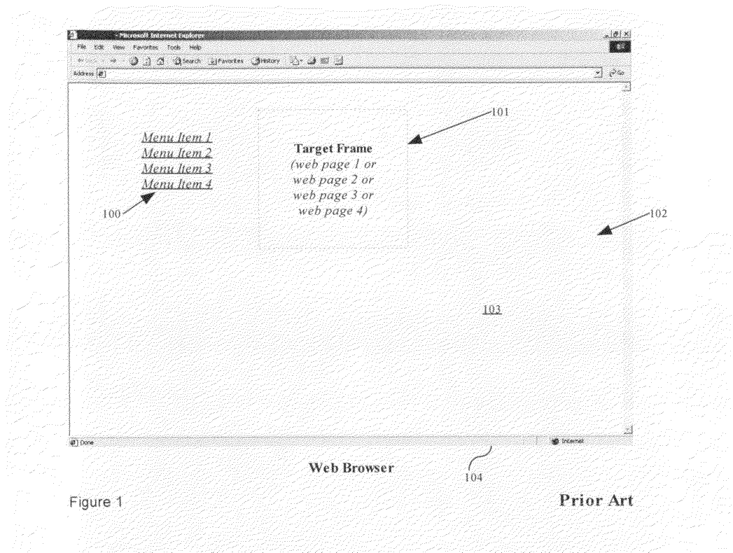

A Web browser is commonly used to navigate the Internet. A Web page is displayed in the content window of the browser. When accessing the Web page, it is also possible to display more than one Web page at the same time in the content window using frame technology. Referring to FIG. 1, the browser content window 102 displays a first Web page 103 located at a specified Uniform Resource Locator (URL). The Web page 103 includes a target frame 101, which displays a second Web page located at a second specified URL, which may or may not be located on the same server as the Web page 103. Frames 101 occupy a rectangular area. Frames 101 can be created in a Web page using one of several commands in HTML supported by various browsers: IFRAME, FRAME, LAYER and ILAYER as provided by Netscape™ Navigator and Microsoft™ Internet Explorer. It is possible to dynamically change the URL that frame 101 points to, so that frame 101 can dynamically display new content. A commonly used navigation aid for navigating a series of independent Web pages, which are hyperlinked together, usually within a Web site, is shown in FIG. 1. Four menu items 100 are implemented as HTML links. The target frame 101 displays a Web page in response to the selection of one of the menu items 100, which is programmed with the URL for that Web page. For example, if a user clicks on menu item 100 labelled “Menu Item 2”, then the target frame 101 will display the Web page associated with “Menu Item 2”. The menu items 100 remain displayed in the content window 102 even as the content of the frame 101 changes.

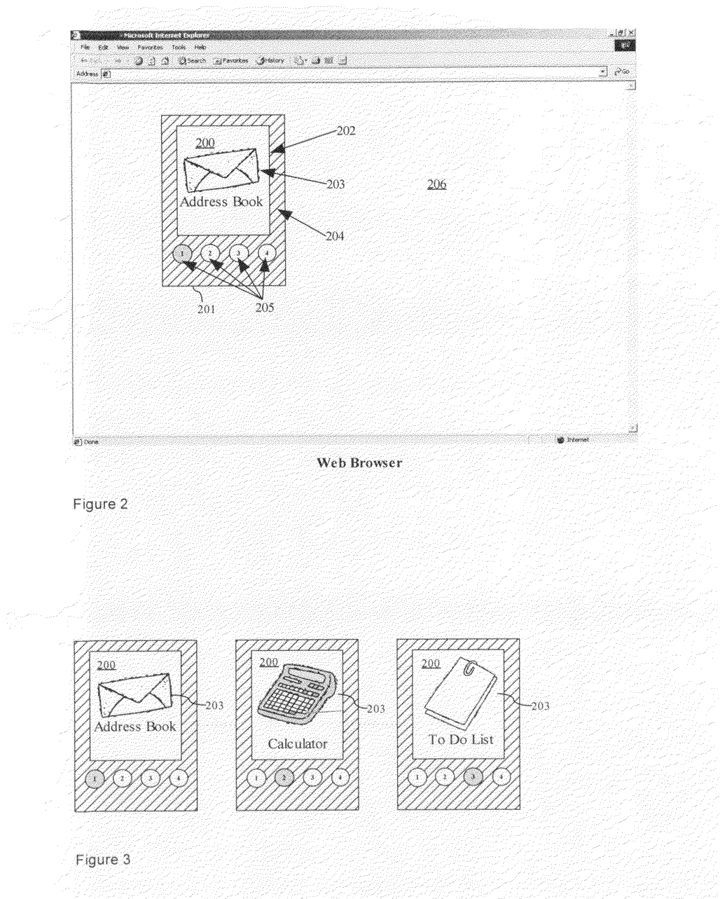

In the present invention, this prior art Web site navigation aid is adapted to access online software applications using a Web browser. An online software application is a series of logically interlinked Web pages, which provide a specific functionality. FIG. 2 depicts a Web page application 206 according to the present invention. The Web page application 206 includes a user interface 201, referred to by the inventor as a Virtual Personal Digital Assistant (VPDA™), that mimics both the appearance and functionality of a PDA. The VPDA 201 includes a graphical border 204, which encloses a target frame 202, which defines a display area 200 for displaying Web pages of an online software application 203. The display area 200 may be on Web page application 206 or may be opened in a new Web page application on the same or on a separate browser. The border 204 is implemented using one or more conventional graphic files such as JPEG or GIF. The target frame 202 is implemented using conventional HTML commands. The VPDA 201 also includes function buttons 205, generally, but not necessarily located within the border 204, which are linked to URL addresses for the home or start page of online software application 203 that can be displayed in the display area 200. The buttons 205 are implemented using a conventional link: the HREF parameter specifying the start page of the online software application 203, and the TARGET parameter specifying the name of the target frame 202. The representations of the buttons 205 are implemented using conventional HTML links, such as image links, text links, or buttons.

Referring to FIG. 3, examples of online software applications 203 which can be “loaded” onto or “unloaded” from the VPDA 201 include Address Book, Calculator and To Do List. Such applications can be linked on the VPDA 201 by a Web administrator who created or maintains the VPDA 201, or such links can be “loaded” and/or “unloaded” dynamically by a user accessing the VPDA 201.

To use the VPDA 201, a user clicks on one of the buttons 205 to bring the associated VPDA software application 203 into the display area 200. Then, the user may navigate through one or more pages of the online application 203, displayed in the display area 200. Clicking on another of the buttons 205 interrupts the current application 203 displayed in the VPDA 201 and displays the new VPDA Software Application 203 associated with the other button 205. For example, clicking on button 1 loads the Address Book, button 2 loads the Calculator and button 3 loads the To Do List.

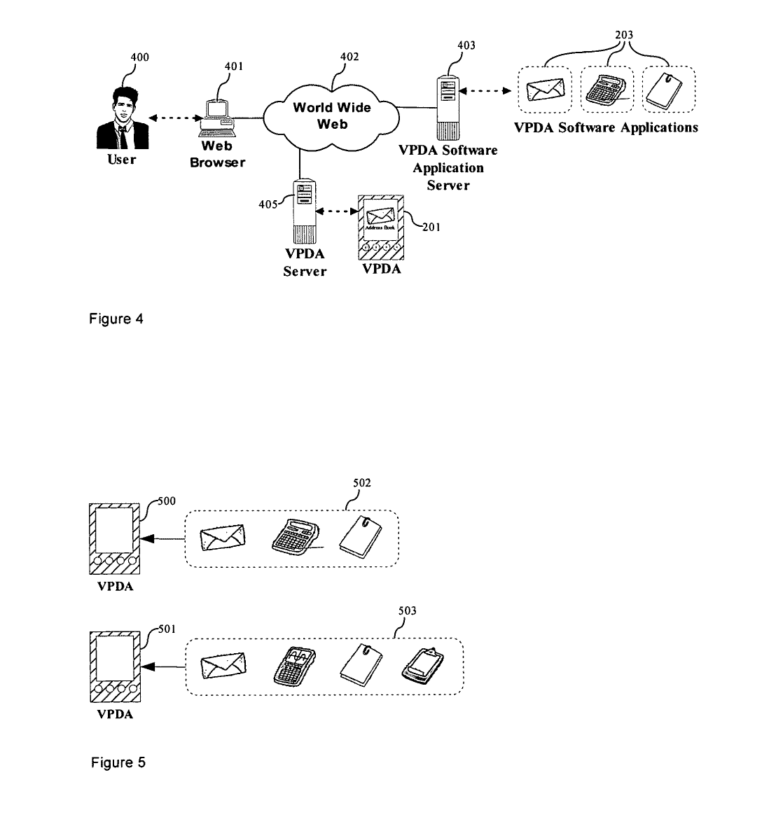

Referring to FIG. 4, to access VPDA software application 203, a user 400, using its Web browser 401, browses the World Wide Web 402 and accesses VPDA 201 located in a VPDA server 405. The user 400 clicks on one of the buttons 205 of the VPDA 201 to select VPDA software application 203. The corresponding VPDA software application 203 is found on a VPDA software application server 403 which can be the same as VPDA server 405 or a different server. Each VPDA software application 203 can be served by a different VPDA software application server 403.

Referring to FIG. 5, since VPDA 201 mimics the functionality of the PDA, it can support the “loading” and “unloading” of applications. Loading VPDA software application 203 consists of associating the URL of the start or home page of VPDA software application 203 with the HREF parameter of the corresponding button 205 accessible by users 400 of the VPDA 201. For example, as shown in FIG. 5, a VPDA 500 allows users 400 to access the Address Book, the Calculator and the To Do List software applications 502. The functionality of a VPDA can be modified by loading other applications. For example, VPDA 501 is another embodiment of the invention, which allows users to access Address Book, Scientific Calculator, To Do List and Clipboard applications 503. The VPDA 501 can be created by modifying the VPDA 500 by unloading the Calculator and loading a new Scientific Calculator to replace it and then loading the Clipboard application and associating it with another button 205 of the VPDA 201 that was unused in creating the VPDA 500.

Like other online software applications, VPDA 201 is mostly accessed by users that interact with the functionality set by an administrator, usually the owner of the VPDA 201.

VPDA software applications 203 can be loaded on the VPDA 201 according to several different methods. The VPDA functionality can be set from existing or newly created Web applications.

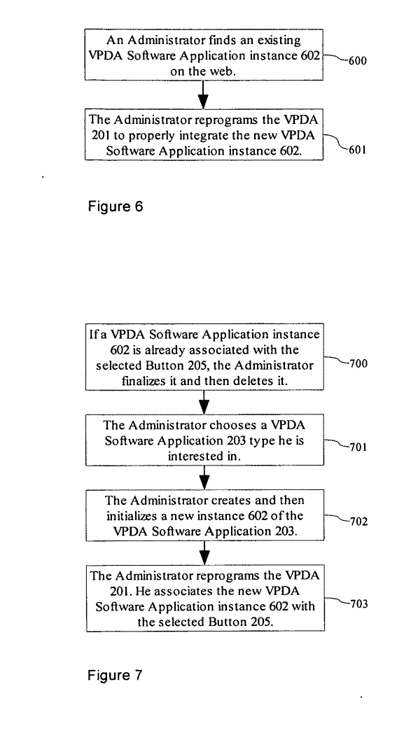

Referring to FIG. 6, in step 600, in a first method, an administrator sets VPDA software applications 203 from existing Web applications by first finding an existing VPDA software application instance 602 on the Web. VPDA software application instance 602 is a live copy of VPDA software application 203. In step 601, the administrator reprograms the VPDA 201 by changing the original HTML code of the VPDA 201 to properly reference the new VPDA software application instance 602. The administrator associates the new VPDA software application instance 602 with one of the buttons 205.

Referring to FIG. 7, in a second method, an administrator sets the VPDA Software Applications 203 from newly created VPDA software application instances 602. In step 700, if an existing VPDA software application instance 602 is already associated with the selected one of the buttons 205 of VPDA 201, the administrator finalizes it and then deletes it. In step 701, the administrator selects VPDA software application 203 type in which he is interested. In step 702, the administrator creates and then initializes a new instance 602 of the VPDA software application 203. In step 703, the administrator reprograms VPDA 201 by changing the original HTML code of the VPDA 201 and associates the new VPDA software application instance 602 with the selected button 205, which was originally associated with previously existing application 203.

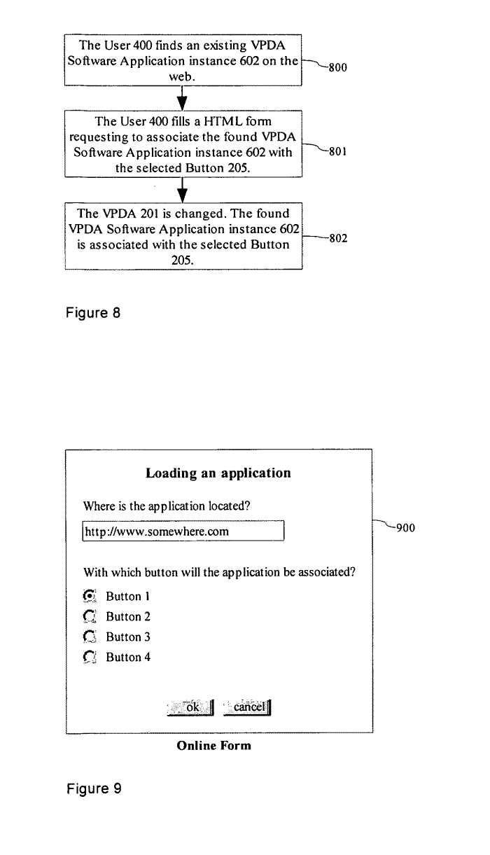

A user can also load VPDA software application 203 into VPDA 201. Referring to FIG. 8, in step 800, the user finds an existing VPDA software application instance 602 on the Web 402. In step 801, the user accesses an online form, such as form 900 (FIG. 9) stored on a server computer. The user 400 first provides a URL where the existing VPDA software application instance 602 is located, then he selects which button 205 will be associated with the software application instance 602 and then clicks on “OK” button to submit the request. The VPDA 201 will then be changed to reflect the requested change in step 802 using standard server side web application development technologies.

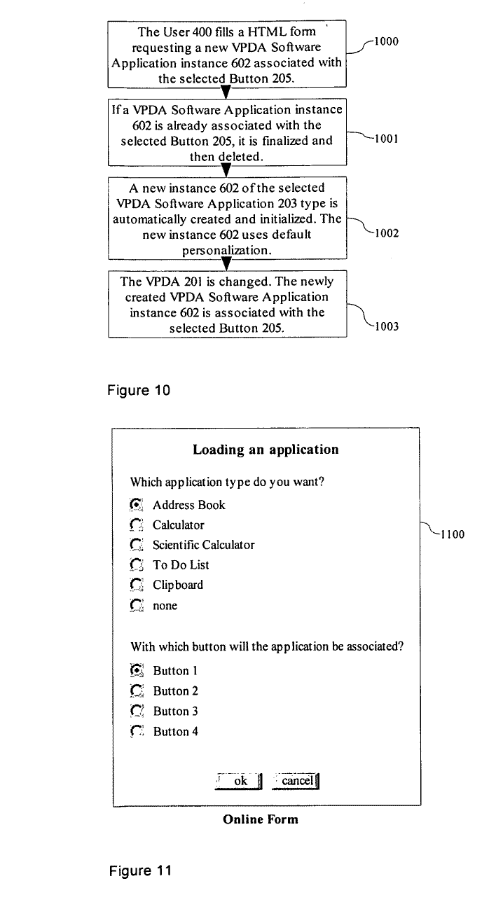

Referring to FIG. 10, users can also set the VPDA software applications 203 from newly created software application instances 602. In step 1000, the user fills in a form such as form 1100 (FIG. 11) to request a new VPDA software application instance 602 be associated with one of the buttons 205. The user first selects the type of application he wants, then he selects which Button 205 will be associated with the application and then clicks on “OK” to submit his request. If an existing VPDA software application instance 602 is already associated with the selected button 205, it is finalized and then deleted (step 1001). A new instance or copy 602 of the selected VPDA software application 203 type is automatically created and initialized. The new instance 602 uses default personalization (step 1002). A more complex form could ask the user for initial parameters to use in place of the default parameters. The VPDA 201 will then be changed and the newly created VPDA software application instance 602 is associated with the selected button 205 to reflect the requested change (step 1003). If the user 400 selects “none” as the application type, then no instance 602 will need to be created, and no application will be associated with the selected button 205.

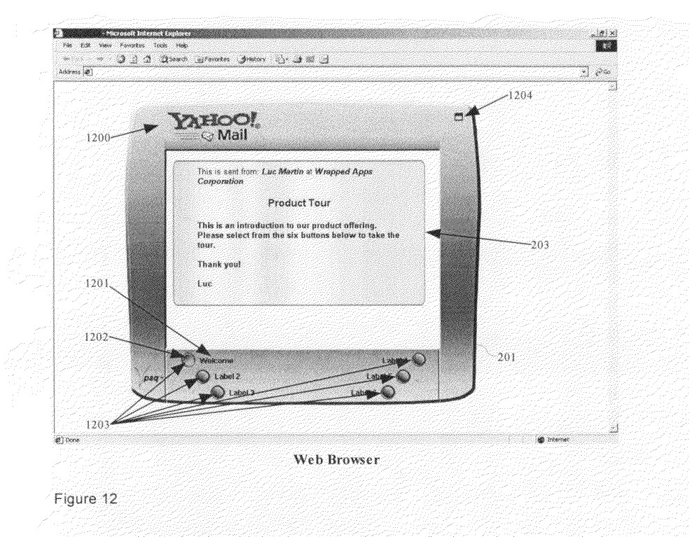

Referring to FIG. 12, a second embodiment of VPDA 201 is shown which offers more sophisticated features. It supports a maximize button 1204 that opens the current VPDA software application 203 in a new full-page browser window for easier browsing. The VPDA 201 can be branded with a logo 1200. A label 1201 can be provided, on each of the six programmable buttons 1203. Finally, a depressed button 1202 can be used to show the currently selected VPDA software application 203.

While reference has been made herein to a PDA, it will be understood that the VPDA of the present invention can be made to resemble other devices such as desk top computers, laptop computers, Palm™ pilots, mobile telephones, hand held devices and other devices which can be used to access/load or unload software applications.

As such, the invention may be embodied in other specific forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

I claim:

1. A graphical user interface displayable in a content window of a Web browser for accessing an online software application, comprising:
a button, the button programmed with a URL of a start page of the online software application;
whereby, clicking on the button causes the start page of the online software application to be displayed in a display area.

2. The graphical user interface of claim 1, wherein the graphical user interface includes the display area.

3. The graphical user interface of claim 2, including a border enclosing the display area and wherein the button is located in the border.

4. The graphical user interface of claim 1, wherein the button is dynamically programmable by a user of the interface.

5. The graphical user interface of claim 1, wherein the button is programmable by an administrator of the interface.

6. The graphical user interface of claim 1, wherein the display area is implemented using an HTML command selected from the group consisting of IFRAME, FRAME, LAYER and ILAYER.

7. The graphical user interface of claim 1, wherein the button is implemented using representation means selected from the group consisting of an HTML text link, an HTML image link and an HTML button.

8. The graphical user interface of claim 1, wherein the interface resembles a PDA and includes a plurality of the buttons to access a plurality of the online software applications.

9. A method for interaction between a Web browser on a first computer and an online software application on a second computer, said method comprising the steps of:
initiating an application on the first computer to open a graphical user interface in the content window of the Web browser, the interface including a button, the button programmed with a URL of a start page of the online software application; and
accessing the start page using the button,
thereby causing the start page to be displayed in a display area to permit interaction with the online software application.

10. The method of claim 9, including accessing a second start page of a second online software application by using a second button programmed with the URL address for the second start page and thereby causing the second start page to be displayed in the display area.

11. A method of accessing an online software application under control of a server system, comprising the steps of:
displaying in a Web browser, a button programmed with a URL of a start page of the online software application;
sending a request to the server system to access the start page of the software application in response to selection of the button; and
displaying the requested start page in a display area.

12. The method of claim 11, including the steps of transmitting, using the Web browser, a request to the server system to associate the start page of the online software application with the button;
receiving permission from the server system to associate the start page with the button; and
associating the start page of the application with the button.

13. A system comprising:
means for creating one or more button means associated with one or more start pages of one or more online software applications;
means for making available the button means via a Web page;
means for selecting one of the button means; and
means for displaying the start page of the online software application associated with the selected button means in a display area in response to selection of the button means.

14. The system of claim 13, including means for permitting a user to associate the one or more button means with the one or more online software applications.

15. The system of claim 14, wherein said means for permitting is an online form.

16. The system of claim 13, including means for permitting an administrator to associate the one or more button means with the one or more online software applications.

17. The system of claim 13 wherein said means for displaying is a graphical user interface which resembles a PDA.

18. The system of claim 17 including a branding graphic.

19. The system of claim 17, including display area maximization means.

20. The system of claim 16, including a depressed button to show the currently selected online software application.

21. A method of associating an online software application with a graphical user interface displayable in a content window of a Web browser, the graphical user interface comprising a button associable with a URL for a start page of the online software application, whereby selecting the button causes the online software application to be displayed in a display area, the method comprising the steps of:
locating an instance of a first said online software application using the Web browser; and
causing the button to be associated with the URL of the start page of the instance of the first said online software application.

22. The method of claim 21, comprising the additional steps of:
locating an instance of a second said online software application using the Web browser;
finalizing and deleting the instance of the first said online software application; and
causing the button to be associated with the URL of the start page of the instance of the second said online software application.

23. The method of claim 21, including the additional step of first causing the creation of a new instance of the first said online software application.

24. The method of claim 21, wherein the step of causing the button to be associated with the URL of the start page of the instance of the first said online software application is accomplished by means of an online form.

25. The method of claim 23, wherein the steps of causing the creation of a new instance of the first said online software application and causing the button to be associated with the URL of the start page of the new instance of the first said online software application are accomplished by means of an online form.

26. The method of claim 22, wherein the steps of finalizing and deleting the instance of the first said online software application and causing the button to be associated with the URL of the start page of the instance of the second said online software application are accomplished by means of an online form.
